(19) United States
(12) Patent Application Publication
(10) Pub. No.: US 2026/0268121 A1
(43) Pub. Date: Sep. 10, 2026

(54) PROTECTION OF NEURAL NETWORK MODELS ON EDGE DEVICES

(71) Applicant: FortifyIQ, Inc., Concord, MA (US)

(72) Inventors: Ury Kreimer, Tekoa (IL); Valery Teper, Petah-Tikva (IL); Yaacov Belenky, Maale Adumim (IL); Alexander Kesler, Boca Raton, FL (US)

(21) Appl. No.: 19/551,288

(22) Filed: Feb. 26, 2026

Related U.S. Application Data
(60) Provisional application No. 63/764,411, filed on Feb. 27, 2025.

(51) Int. Cl. G06N 3/047; G06F 12/14; H04L 9/00

(52) U.S. Cl. CPC G06N 3/047; G06F 12/14; H04L 9/003

(57) ABSTRACT

Techniques are directed to integrating a trusted execution environment directly into an edge device, physically locating both a secure “protected” processor block and a standard “untrusted” processor block on the same motherboard or chip. Rather than encrypting the entire neural network—which may be computationally prohibitive—the technical solution involves decomposing the parameter values using techniques like Singular Value Decomposition so that the vast majority of parameter values are stored unencrypted in the untrusted block, as they reveal no intellectual property on their own. Only a small, highly sensitive set of parameter values is kept in the protected block where they may be secured with, e.g., efficient, on-the-fly decryption.

### CROSS REFERENCE TO RELATED APPLICATIONS

This application claims the benefit of U.S. Provisional Application No. 63/764,411, filed on Feb. 27, 2025, the disclosure of which is hereby incorporated by reference in its entirety.

### BACKGROUND

Some models such as neural networks, which can include large language models (LLMs) are trained, or generated, at large data centers that can handle the computational load. In generating such a model, a large data center may produce a large number of weights, or parameter values that represent a model. For example, the parameter values can take the form of a set of large matrices for each layer (e.g., convolutional, pooling, output) of the model. The large data center may then make the model available to a device configured to perform inference on the model from inputs. To do this, the device may store the parameter values of the model on local storage.

### SUMMARY

The concepts discussed herein are directed to an edge device configured to perform inference on a model securely and efficiently. To achieve these ends, the edge device has at least two processing blocks, each with a processing unit (e.g., central processing unit (CPU), graphics processing unit (GPU), etc.) and memory. While at least one of the processing blocks can be a conventional block with a processing unit and unprotected memory, the other processing block can have a processing unit coupled to a protected memory. In this context, a protected memory is configured to store a portion of the parameter values in an encrypted form. However, because encryption and subsequent decryption can be resource-intensive, the portion of the parameter values stored in the protected memory may be a small portion of the total number of parameter values.

In a general aspect, a method can include receiving, by an edge device having a first processor block and a second processor block, a first set of parameter values and a second set of parameter values representing at least a portion of a model generated by a remote device, the first set of parameters being encrypted, the first processor block including a processing unit and a protected memory, the second processor block including a processing unit and an unprotected memory. The method can also include sending the first set of parameter values from the second processor block to the first processor block. The method can further include storing the first set of parameter values in the protected memory. The method can further include storing the second set of parameter values in the unprotected memory. The method can further include generating an output of the model based on the first set of parameter values and the second set of parameter values.

In another general aspect, a computer program product can include a nontransitory storage medium and code that, when executed by processing circuitry, causes the processing circuitry to perform a method. The method can include receiving, by an edge device having a first processor block and a second processor block, a first set of parameter values and a second set of parameter values representing at least a portion of a model generated by a remote device, the first set of parameters being encrypted, the first processor block including a processing unit and a protected memory, the second processor block including a processing unit and an unprotected memory. The method can also include sending the first set of parameter values from the second processor block to the first processor block. The method can further include storing the first set of parameter values in the protected memory. The method can further include storing the second set of parameter values in the unprotected memory. The method can further include generating an output of the model based on the first set of parameter values and the second set of parameter values.

In another general aspect, a system can include a remote device and an edge device. The remote device can include memory and processing circuitry coupled to the memory. The processing circuitry can be configured to generate a plurality of parameter values; generate, from the plurality of parameter values, a first set of parameter values and a second set of parameter values; and encrypt the first set of parameter values. The edge device can include a first processor block and a second processor block. The first processor block can include a protected memory and a processing unit coupled to the protected memory. The second processor block can include an unprotected memory and a processing unit coupled to the unprotected memory. The processing unit of the first processor block can be configured to store the first set of parameter values in the protected memory. The processing unit of the first processor block can also be configured to store the second set of parameter values in the unprotected memory. The processing unit of the first processor block can further be configured to generate an output of the model based on the first set of parameter values and the second set of parameter values.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram illustrating an example system for training and storing a model, according to the implementations described herein.

FIG. 2A is a diagram illustrating an example edge device with protected and unprotected processor blocks.

FIG. 2B is a diagram illustrating an example edge device with protected and unprotected processor blocks with on-the-fly decryption and authentication.

FIG. 3A is a sequence diagram illustrating an example process for decomposing the parameter values representing a model.

FIG. 3B is a sequence diagram illustrating an example randomization precomputation.

FIG. 3C is a sequence diagram illustrating an example criterion evaluation.

FIG. 4 is a flow chart illustrating an example method of storing a model and performing inference, according to the implementations described herein.

### DETAILED DESCRIPTION

The technology described herein enables protecting valuable Artificial Intelligence (AI) models, such as those used for language processing, when they are run on everyday devices like smartphones, medical equipment, or car computers. Typically, placing a complete AI model on an “edge device” (a device at the edge of a network, rather than in a secure data center) is risky because hackers could steal the expensive large set of parameters, that make the model work. To address this security problem, the technology splits the hardware inside the device into two distinct sections: a “protected” processor block that acts like a secure vault, and an “unprotected” processor block that handles standard tasks.

The system works by breaking down the AI model's parameters-specifically the weights used in its calculations—into two separate sets. A small subset of parameters is kept inside the protected memory. These secrets are often encrypted (scrambled) and only decrypted for a split second when they are actually being used, making them very hard to steal. The remaining majority of the parameters, which are not enough to use the model without the subset stored in the protected memory, are stored in the unprotected memory to handle the bulk of the computational work.

When the device needs to use the AI to answer a question or process data, the two sections coordinate using a secure method. The protected section takes the input data and adds random “noise” to it, effectively masking the real information before sending it to the unprotected section. The unprotected section performs the heavy mathematical calculations on this masked data and sends the result back. Finally, the protected section removes the noise to reveal the correct answer and checks to make sure the calculation was done correctly, ensuring the AI model remains secure even if the unprotected part of the device is compromised.

Conventional model inference involves a security framework for models such as neural networks and LLMs known as “weights decomposition,” exemplified by a solution called “SLIP” (Securing LLM's IP). This conventional model inference is designed to mitigate the security risks associated with offloading the inference of trained models-such as Large Language Models (LLMs)—from secure data centers to less secure edge devices like smartphones or IoT devices. The framework operates by splitting the model's inference process into two parts: a trusted party located in a well-protected data center and an untrusted party located on the edge device.

In this conventional model inference, the model parameters and computational workload can be distributed between the cloud and the edge device. To maximize efficiency, the vast majority of the model parameters are stored on the untrusted edge device, which also performs most of the heavy computational tasks. The sensitive, highly informative parameters remain in the secure data center, and the two parties interact via a communication protocol to generate the final model output without exposing the core intellectual property to the edge device.

A technical problem with the conventional model inference is its dependence on continuous connectivity to the data center. In many real-world scenarios, such as those involving autonomous vehicles or medical devices, the entire inference process might be performed locally on the edge device due to a lack of reliable internet connectivity or the need for immediate, real-time responses. Attempting to adapt the conventional method by simply storing all parameters on the edge device in an encrypted format creates new challenges; decrypting the massive volume of parameters required for a full neural network would essentially double the computational workload and significantly slow down the inference process, making it unviable for many applications.

A technical solution to the technical problem addresses the latency and connectivity issues of cloud-based security by integrating the trusted execution environment directly into the edge device, physically locating both a secure “protected” processor block and a standard “untrusted” processor block on the same motherboard or chip. Rather than encrypting the entire neural network—which may be computationally prohibitive—the technical solution involves decomposing the parameter values using techniques like Singular Value Decomposition so that the vast majority of parameter values are stored unencrypted in the untrusted block, as they reveal no intellectual property on their own. Only a small set of parameter values is kept in the protected block where they may be secured with, e.g., efficient, on-the-fly decryption. In some implementations, during use, the protected block secures the inference by masking input data with random noise before sending it to the untrusted block for the heavy mathematical lifting; once the calculation is returned, the protected block removes the noise and verifies the result's integrity, ensuring the model remains secure and functional even without an internet connection.

A technical advantage of the technical solution is an improvement in computational efficiency and processing speed compared to protecting a model solely through full encryption. As described in the sources, attempting to secure an entire Large Language Model (LLM) locally by storing all parameters in an encrypted format would require the device to decrypt billions of coefficients for every inference, a massive computational workload that can render real-time applications unviable. By physically locating both a protected processor block and an unprotected processor block on the same edge device and utilizing weights decomposition, the system allows the vast majority of parameters—which are not enough by themselves to use the model—to be stored unencrypted in the unprotected memory. This ensures that on-the-fly decryption is used only for the small fraction of sensitive parameters managed by the protected block, making the security process less resource-intensive while also eliminating the latency and connectivity dependence associated with cloud-based inference.

Using the disclosed techniques, the above-described technology can be used in autonomous vehicles and “vehicle core processing units (CPUs),” which must often perform complex AI inferences locally due to “real-time requirements” and potential “lack of connectivity” on the road. In this scenario, the vehicle acts as the edge device, using the invention's split architecture to process sensor data immediately without waiting for a response from a remote data center. The intellectual property of the self-driving model—specifically the billions of coefficients that define its decision-making—is protected within the vehicle's protected processor block, ensuring that even if a hacker gains physical access to the car's standard electronics, they cannot steal the model.

In another example, medical devices and internet of things (IoT) devices may frequently operate in environments where data privacy is paramount or internet access is unreliable. These devices can utilize the described “weights decomposition” to perform full model inferences directly on the hardware. By storing the vast majority of parameters in the unprotected memory and only a small amount of parameters in the protected memory, manufacturers can deploy expensive, highly trained models to portable medical equipment without the risk of the model being stolen from it and/or maliciously modified. This allows for sophisticated medical analysis to happen at the point of care while keeping the proprietary algorithms secure.

In another example, the AI model on the edge device may be periodically updated with new capabilities via signed and encrypted files. The protected processor block may be used for performing the decryption process and signature checks using a secret key. Without the architecture defined in the technical solution, this process could be vulnerable to side-channel attacks where an adversary could monitor power consumption or electromagnetic emissions to steal the decryption key. The technical solution can mitigate this by confining these sensitive operations—and the interaction between the protected and unprotected blocks during inference—to a secure environment fortified with defenses like TI, DOM, RAMBAM, or STORM.

As used herein, an “edge device” refers to a hardware computing unit located at the periphery of a network that performs processing tasks locally rather than relying entirely on a centralized data center or cloud. While generally understood in the broader art as equipment like routers or gateways, in the specific context of this disclosure, the edge device is defined by a specialized architecture containing both a “first processor block” (functioning as a trusted party with protected memory) and a “second processor block” (functioning as an untrusted party with unprotected memory) physically integrated on the same motherboard, package, or chip. Examples of edge devices include internet of things (IoT) devices, medical devices, vehicle core processing units (CPUs), smart watches, smart glasses, and smartphones, which may perform complex tasks like LLM inference locally due to real-time requirements or a lack of connectivity, despite being inherently less protected than data centers.

As used herein, a “remote device” refers to a centralized computing system, such as a data center or cloud-based server, that possesses the high computational power required for model training and the fine tuning of model parameters. In this context, the remote device may include processing circuitry and memory for generating a model and subsequently transmitting the resulting parameter values via a network to an edge device for inference. While the technical solution focuses on performing inference locally on the edge device, the remote device serves as the external origin where the model is initially created and from which the coefficients are received after being decomposed into protected and unprotected sets.

As used herein, a “processor block” refers to a distinct hardware partition within a computing system—specifically an “edge device” that comprises a dedicated processing unit coupled with an associated memory tier, configured to execute a specific portion of a distributed computational workload. In the context of the provided sources, the architecture explicitly divides the device into two such blocks: a first processor block which includes protected memory for securing the small first set of parameter values and performing operations like on-the-fly decryption and verification; and a second processor block which includes unprotected memory for storing the vast majority of parameter values and performing bulk matrix operations. These blocks are physically integrated within the same local hardware environment—such as on the same motherboard, in the same package, or on the same chip—to allow for efficient, low-latency communication while maintaining a strict logical separation that prevents the unprotected block from accessing the secret keys or parameter values isolated within the protected block.

As used herein, “parameter values” refers to internal numerical variables—such as weights, biases, and matrix coefficients—that are learned during the training process of a machine learning model, and which define its specific functional behavior and decision-making logic. In the context of the provided sources, these values may represent the coefficients of matrices that constitute the layers of a model such as a neural network or Large Language Model (LLM) and can number in the billions or more. Within the described architecture of the technical solution, the plurality of parameter values may represent a core intellectual property of the model and may be mathematically decomposed by the remote device (e.g., via Singular Value Decomposition) into a first set of parameter values stored in protected memory and a second set of parameter values containing the majority of the parameter values which are stored in unprotected memory.

As used herein, a “model” refers to a machine learning architecture, such as a neural network or Large Language Model (LLM), that serves as the foundation for Artificial Intelligence (AI) tasks like generating responses or processing data. Composed of a plurality of layers which may be represented as matrices containing billions of coefficients or parameter values, the model embodies the learned intelligence and proprietary intellectual property of a system. In the context of the described technology, the model is typically generated by a remote device (such as a secure data center) and then offloaded to an edge device for inference, after it is mathematically decomposed in the remote device—specifically via techniques like Singular Value Decomposition (SVD)—into a first set of parameter values (sensitive) and a second set of parameter values (non-sensitive) to protect the model's functional logic from being stolen or maliciously modified.

As used herein, a “processing unit” refers to the computational hardware or circuitry—such as a Central Processing Unit (CPU), digital signal processor (DSP), application-specific-integrated circuit [ASIC], or field programmable gate array (FPGA)—configured to execute machine instructions and manipulate data within a specific partition of an edge device. Distinct processing units may be instantiated within both a protected processor block (the trusted environment) and an unprotected processor block. The processing unit coupled to the protected memory is configured to perform security-critical operations, such as performing on-the-fly decryption and verifying the integrity of calculations via authentication. Conversely, the processing unit coupled to the unprotected memory may be tasked with handling bulk computational workloads, such as receiving a randomized output from the protected block and computing products using the second set of parameter values.

As used herein, “protected memory” refers to a secure hardware storage component or designated partition physically located within the first processor block (or trusted enclave) of an edge device, which is isolated from the unprotected memory and the general processing environment. In some implementations, the secure hardware storage component or designated partition is external but encrypted. This memory may be coupled to a processing unit and is specifically utilized to store the small first set of parameter values—such as the top singular components or the most informative weights of a neural network—which constitute the core intellectual property of the model. To ensure confidentiality, the contents of the protected memory may be stored in an encrypted format, accessible only through specialized mechanisms like on-the-fly decryption and authentication and are frequently fortified against physical threats such as side-channel attacks to prevent the leakage of secret keys or model coefficients during the inference process.

As used herein, “unprotected memory” refers to a hardware storage component or designated partition located within the second processor block (or untrusted environment) of an edge device, which is distinguished from the secure protected memory by its lack of stringent security measures like encryption. In some implementations, the hardware storage component or designated partition is external. In the context of the disclosed invention, this memory is coupled to a standard processing unit and is configured to store the second set of parameter values—which constitutes a majority of a neural network's weights—because these specific parameters are mathematically decomposed to reveal zero information regarding the full functional model in isolation. Functioning as the storage for the untrusted party, the unprotected memory facilitates the bulk of the computational workload, such as heavy matrix multiplications, without requiring an on-the-fly decryption or secure enclaves reserved for the model's sensitive intellectual property.

As used herein, “output” refers to the data generated by the computational operations of the neural network, encompassing both the intermediate results produced by individual model layers and the final result generated by the complete model. In the context of the disclosed invention, the term specifically describes various states of data as it is processed between the trusted and untrusted environments, including the output of a previous layer which serves as the input for a current calculation, and the randomized output—a version of the data masked with a random vector to prevent the unprotected processor from viewing the raw information. Furthermore, it may include partial calculation results such as the first output of the layer derived by the protected block and the second output of the layer derived by the unprotected block, which are ultimately combined and processed (e.g., via an activation function) to generate the final output of the model, such as an LLM response or classification.

As used herein, a “layer” refers to a distinct functional stage or computational level within a neural network architecture, such as a Large Language Model (LLM), which processes data by transforming an output of a previous layer into a new output. In the context of the provided sources, a layer is typically represented mathematically as a matrix of parameter values or coefficients—often performing matrix-vector multiplications—and includes specific types such as linear layers, attention layers, fully connected layers, and convolutional layers. Within the described security framework, the layer serves as the primary unit for “model decomposition,” wherein its weight matrix is split (e.g., via Singular Value Decomposition) into a small first set of parameter values handled by the protected processor block and a large second set of parameter values offloaded to the unprotected processor block.

As used herein, a “weight” refers to a numerical coefficient or parameter value that defines the strength of a connection or the functional contribution of a specific component within a machine learning model. In the context of a neural network or Large Language Model (LLM), weights typically manifest as the billions of coefficients populating the matrix of parameter values that constitute a model layer. More specifically, within a weight decomposition framework (e.g., Singular Value Decomposition), weights may be distinct scalar values—such as singular values—derived from the layer matrix, where each weight is associated with a specific submatrix. These weights are used for reconstructing the model's logic, as the parameter values are generated as a weighted sum of these submatrices, with the weights often segregated into a first set and second set to distinguish between the parameters kept in protected memory and those offloaded to unprotected memory.

As used herein, a “submatrix” refers to a constituent matrix component derived from the mathematical decomposition of a layer within a neural network, specifically representing a fundamental building block of the model's matrix of parameter values. While in linear algebra a submatrix may be formed by deleting rows or columns, in the specific context of the disclosed weights decomposition (utilizing techniques such as Singular Value Decomposition or SVD), the term describes the independent matrix units—mathematically equivalent to the rank-1 outer products of singular vectors uⱼvⱼ^{T} that are each associated with a specific scalar weight or singular value. These submatrices serve as the basis for reconstructing the model, as the parameter values are generated via a weighted sum of these components. To secure the model's intellectual property, these components are segregated into a first set of submatrices which are handled by the protected processor block, and a second set of submatrices which are offloaded to the unprotected memory.

As used herein, “randomized output” refers to data—typically the output generated by a previous computational layer of a machine learning model or neural network—that has been mathematically masked or obfuscated with random noise to conceal its true, underlying information. In the context of the described secure hybrid inference architecture, the processing unit of the trusted first processor block produces the randomized output by generating a random vector based on a probability distribution function and adding this random vector to the true output of the previous layer. This masked data is subsequently transmitted to the untrusted second processor block so that the unprotected processing unit can perform computationally heavy operations, such as matrix multiplications using non-sensitive parameter values, without ever being exposed to the raw, sensitive intermediate data. After the unprotected block processes this obfuscated information, it returns a randomized second output back to the protected block, which then securely removes the random noise—a process known as unmasking—and evaluates specific criteria to verify the integrity of the calculation before deriving the correct final output for that layer.

As used herein, a “random vector” refers to an array of numerical values generated stochastically, often used in computational and cryptographic systems to introduce noise or mask underlying data. In the context of the described secure hybrid inference architecture, a random vector is generated based on a probability distribution function. A random vector serves as a core component of a masking protocol that ensures secure interaction during inference between the trusted and untrusted hardware partitions. Specifically, the trusted processor block produces a randomized output by adding the random vector to the output of the previous layer before sending this data to the untrusted second processor block. By adding this random noise, the system mathematically obscures the sensitive intermediate calculations, causing the untrusted processing unit to perform heavy computational workloads without ever gaining access to the true, unmasked data or recovering the model's core intellectual property.

As used herein, a “mask” refers to a pattern of data or a mathematical construct used to obscure, filter, or subsequently reveal underlying information. Within the specific context of the described secure hybrid inference architecture, a mask—often referred to as a cancellation mask—is a targeted mathematical value generated by the trusted protected processor block to securely remove noise from obfuscated computations. Specifically, the mask is generated by multiplying a stochastically generated random vector by the second matrix (which represents the second set of parameter values handled by the untrusted party). During the unmasking phase of the inference protocol, this mask may be combined with (e.g., subtracted from, added to) the randomized second output that is returned by the unprotected processor block. This operation may allow the protected block to mathematically strip away the random noise that was initially added to the input, thereby recovering the true, unmasked intermediate output of the neural network layer without ever exposing the raw data to the unprotected memory.

As used herein, a “random matrix” refers to a mathematical array populated by random variables generated according to a specific probability distribution. In this context, a random matrix may be generated based on a probability distribution function (e.g., sampled uniformly at random) by the trusted first processor block during a pre-computation phase. The purpose of the random matrix is to enable an integrity check of the heavy computations offloaded to the untrusted second processor block. To achieve this, the protected processor block multiplies the non-sensitive second matrix (which is stored in unprotected memory) by the random matrix to create a pre-computed verification matrix. During the unmasking phase of the inference protocol, the protected block retrieves the precomputed random matrix to perform a linear layer check. The protected block evaluates a security criterion: it checks if the product of the verification matrix and the randomized output is equal to a product of the random matrix and the randomized second output of the layer. If this equation balances, the trusted block accepts the calculation, ensuring that the untrusted processing unit did not maliciously modify the data during its local computation.

As used herein, a “verification matrix” refers to a mathematical array pre-computed by a secure system to authenticate the integrity of outsourced computational tasks. Within this framework, the verification matrix is generated during an off-line pre-computation phase by the trusted first processor block. It may be constructed by multiplying the second matrix—which represents the “second set of parameter values” stored in unprotected memory—by a stochastically generated random matrix. During the active inference process, the protected processor block retrieves this verification matrix to perform a linear layer check. This check evaluates a critical security criterion, verifying if the “product of the verification matrix and the randomized output” (the masked data sent to the untrusted block) is strictly “equal to a product of the random matrix and the randomized second output of the layer” (the calculation returned by the untrusted block). If this equation holds, the trusted block accepts the result, ensuring that the untrusted “second processor block” executed the correct operations without maliciously altering the data.

As used herein, “encryption” refers to the cryptographic process of converting plaintext data into a secure, coded format (ciphertext) to prevent unauthorized access and ensure confidentiality. In this context, encryption is utilized to protect the first set of parameter values managed by the trusted first processor block by sending them in the encrypted form by the remote device and securely storing them in protected memory. To balance security with computational efficiency, the system relies on efficient encryption algorithms, such as lightweight algorithms like Ascon, PRESENT, and KATAN, or compact Advanced Encryption Standard (AES) implementations like RAMBAM and STORM. These encrypted parameters are accessed via on-the-fly decryption only when immediately needed during an inference task. Additionally, encryption may be used to secure periodic model updates, which are transmitted as encrypted files and decrypted using a secret symmetric (e.g., AES) key. Within this system, the encryption and decryption protocols are specifically configured to protect the sensitive data and keys against physical vulnerabilities, including side-channel and fault injection attacks.

As used herein, “on-the-fly decryption” refers to the process of automatically decoding encrypted data exactly at the moment it is accessed or needed by a system, without requiring the entire dataset to be decrypted in advance. In this context, this technique is used by the trusted first processor block to protect the secrecy of the sensitive first set of parameter values. Instead of decrypting all of a neural network's weights—which would be computationally prohibitive and significantly slow down the inference process—only the small fraction of critical parameters stored in the protected memory are kept in an encrypted format and decrypted only for immediate use or whenever they are used. This targeted on-the-fly decryption is often paired with authentication measures (such as AES GCM) and makes securing the model's intellectual property much more affordable computationally than attempting to decrypt all parameters simultaneously.

As used herein, “authentication” refers to the cryptographic security process of verifying the integrity and origin of data to ensure it has not been maliciously altered or forged. Within the specific context of the disclosed secure hybrid inference architecture, authentication is a mechanism utilized by the trusted first processor block to guarantee the integrity of the trusted party's data. Specifically, when the secure processing unit accesses the sensitive first set of parameter values stored in the protected memory, it performs on-the-fly decryption and authentication, frequently employing authenticated encryption protocols like AES GCM. To maintain rigorous security in a physically exposed edge device environment, these authentication algorithms are preferably implemented with robust hardware defenses to protect against physical vulnerabilities, including side-channel and fault injection attacks.

As used herein, a “side-channel attack” refers to a physical security exploit that extracts sensitive information from a computing system by observing its physical operational characteristics—such as power consumption, execution timing, or electromagnetic emissions—rather than directly attacking its underlying algorithms or software code. Within this context, side-channel attacks are identified as a critical physical threat against the edge device's trusted first processor block. Specifically, an adversary could use these attacks during the processing of encrypted model updates to reveal the secret symmetric (e.g., AES) key, allowing them to decrypt and steal the proprietary model updates. Additionally, during active inference, as the trusted block processes unprotected data sent from the untrusted second processor block, side-channel attacks could potentially reveal the first set of parameter values hidden in the protected memory, even if that memory is properly encrypted. To mitigate these severe vulnerabilities, the system may employ specialized hardware defenses for both cryptographic and linear algebra operations, including lightweight encryption algorithms protected against physical attacks, compact AES implementations like RAMBAM and STORM, and share-based protections such as Threshold Implementation (TI) and Domain-Oriented Masking (DOM).

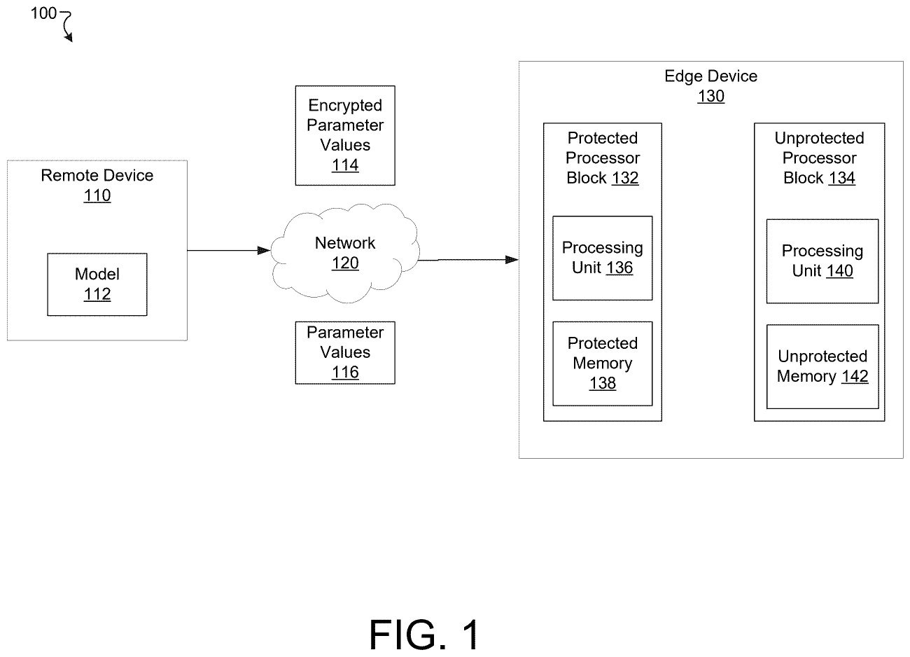

FIG. 1 is a diagram illustrating an example system 100 for training and storing a model. The system 100 is configured for the secure deployment and execution of a machine learning architecture. At a high level, the system 100 includes a remote device 110, a network 120, and an edge device 130. This architecture addresses the technical challenge of securely offloading heavy computational workloads from trusted data centers to physically accessible, lower-security devices without exposing sensitive intellectual property to theft or modification.

The remote device 110 functions as a centralized computing environment, such as a well-protected data center, where intensive model training and fine-tuning occur. The remote device 110 includes memory and processing circuitry configured to generate a model 112 (e.g., a neural network, a LLM). This model 112 represents a fully trained model which embodies the core intelligence of the system.

The model 112 may be mathematically represented by a plurality of parameter values 114 encrypted by the remote device 110 and a plurality of parameter values 116. These parameter values 116 can comprise many (e.g., billions) matrix coefficients that define the specific functional logic and learned behaviors of the neural network. After the model 112 is fully generated, these parameter values 114 and 116 may be distributed to local devices to perform active inference tasks.

As shown in FIG. 1, the system 100 utilizes a network 120 to transmit the plurality of parameter values 114 and 116 from the remote device 110 to the target deployment hardware. As depicted by the visual flow in FIG. 1, the arrows describe the flow of the parameter values 114 and 116 which are received by the edge device 130 specifically at the unprotected processor block 134.

The edge device 130 represents the local hardware where the actual model inference will be performed, such as an Internet of Things (IoT) device, medical device, vehicle CPU, smart watch, smart glass, or smartphone. To ensure the security of the intellectual property during inference, the edge device 130 physically integrates two distinct hardware partitions-a first processor block and a second processor block-within the same local environment, such as on the same motherboard or chip.

The first processor block of the edge device 130 is illustrated as the protected processor block 132. This partition acts as the secure trusted party within the hardware environment. The protected processor block 132 includes a dedicated processing unit 136 coupled to a protected memory 138.

It is noted that the remote device, after training, prior to sending parameter values 114 and 116 to the edge device 130, performs a mathematical decomposition of parameter values generated by the remote device 110 via, e.g., SVD. Specifically, the remote device 110 is configured to generate, from a plurality of parameter values, a first set of parameter values 114 (after encryption) and a second set of parameter values 116.

This separation is mathematically rooted in a technique such as Singular Value Decomposition (SVD), wherein the protected parameter values 210 consist of the top singular components or a first set of weights. The unprotected parameter values 212 consist of the remaining weights which constitute the vast majority of the model's size but bear zero information regarding the full functional model if intercepted by an attacker in isolation.

Specifically, let W∈ [symbol] ^{m+n} be a matrix of parameter values, corresponding to a layer of a model. The SVD of W takes the following form.

$$W = {\sum }_{j = 1}^{r} {σ}_{j} {u}_{j} {v}_{j}^{T} ,$$

where σⱼ∈ [symbol] _{≥0} are the singular values in decreasing order, uⱼ∈ [symbol] ^{m} and vⱼ∈ [symbol] ⁿ are the left and right singular vectors, and r≤min {m, n} is the rank of W. The sensitive portion [symbol] retained by the protected processor block 132 is defined to be the top k singular components of W,

$${W}^{𝒞} = {\sum }_{j = 1}^{k} {σ}_{j} {u}_{j} {v}_{j}^{T} ,$$

and the remaining portion [symbol] offloaded to the unprotected processor block 134 to be the remaining components

$${W}^{D} = {\sum }_{j = k + 1}^{r} {σ}_{j} {u}_{j} {v}_{j}^{T} .$$

To minimize the amount of computing on the protected processor block 132, a value of k<<r, for example k<10, may be chosen to ensure usefulness and to prevent a trivial reconstruction attack.

The first set of parameter values 114 comprises a subset of the parameters of the model 112, such that without the subset the remaining parameters have no practical value for an adversary. To secure this proprietary data, the processing unit 136 is configured to store the first set of parameter values exclusively in the protected memory 138. The protected memory 138 maintains these sensitive values securely, often utilizing an encrypted format that requires on-the-fly decryption and authentication to prevent unauthorized access and physical side-channel attacks.

The second processor block of the edge device 130 is illustrated as the unprotected processor block 134. This partition acts as the untrusted party within the edge device environment, tasked with handling the bulk of the computationally heavy standard inference operations. The unprotected processor block 134 includes its own independent processing unit 140 coupled to an unprotected memory 142.

After the model decomposition is performed by the remote device 110 and the parameter values 114 and 116 are sent to the edge device 130, the processing unit 140 is configured to send the first set of parameter values 114 to the first processor block for storage in the protected memory 138.

Ultimately, the edge device 130 uses both the protected processor block 132 and the unprotected processor block 134 to perform a secure hybrid inference protocol. The system generates an output of the model 112 based on the combined mathematical evaluations using both the first set of parameter values securely managed by the processing unit 136 and the second set of parameter values processed by the processing unit 140.

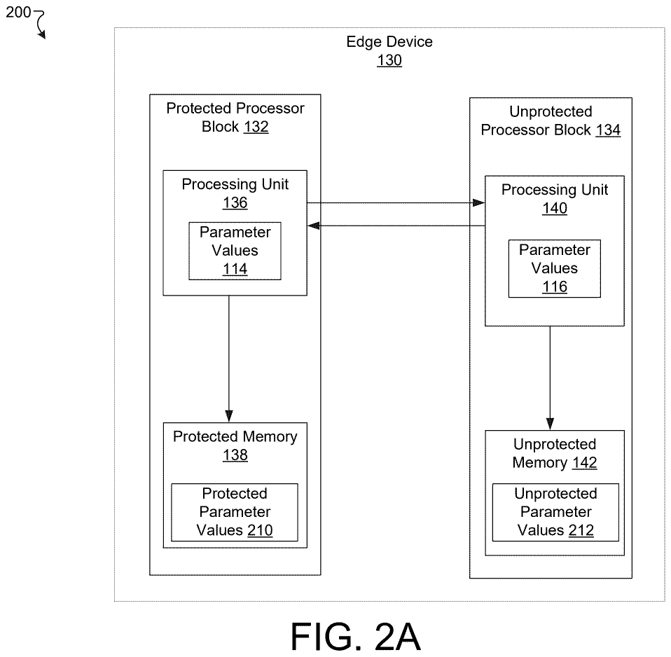

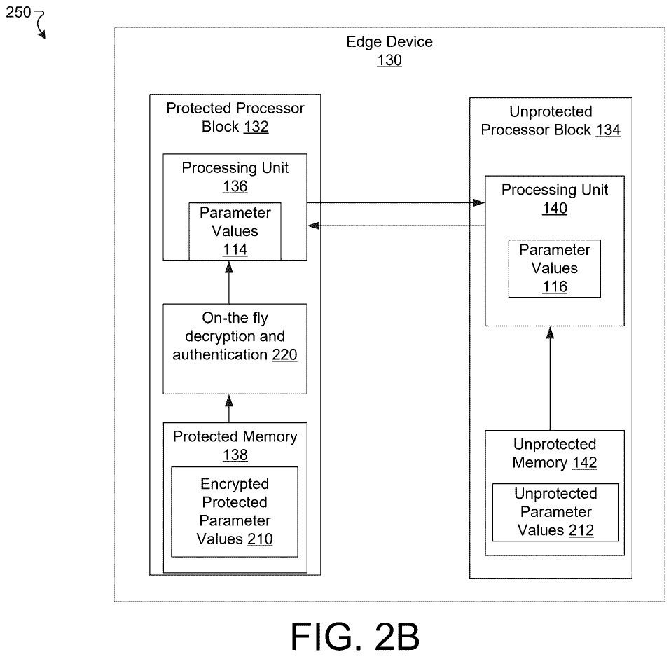

FIG. 2A is a diagram illustrating the edge device 130 with protected and unprotected processor blocks 132 and 134, respectively. FIG. 2A details the internal hardware architecture of the edge device 130 configured for the secure execution of a machine learning model. This architecture addresses the technical challenge of securely performing neural network inference locally without exposing the proprietary model data to theft or malicious modification.

Unlike conventional solutions that divide computations between a remote data center and a local device, the system 200 physically co-locates both the trusted and untrusted computational parties within the same edge device 130. These two distinct processing partitions can physically reside on the same motherboard, in the same package, or even within the exact same chip, allowing the device to perform complete inferences locally to satisfy real-time operational requirements or mitigate a lack of network connectivity.

The process begins when the remote device 110 generates a plurality of parameter values. These parameter values represent a fully trained neural network model.

As shown in FIG. 2A, the first highly secure partition within the edge device 130 is designated as the protected processor block 132. Functioning as the trusted party, the protected processor block 132 comprises a dedicated processing unit 136 which is securely coupled to a protected memory 138. Conversely, the second partition is designated as the unprotected processor block 134. Functioning as the untrusted party, the unprotected processor block 134 comprises its own independent processing unit 140 coupled to an unprotected memory 142.

Upon generating model parameter values, the remote device 110 is configured to perform a mathematical decomposition. From these overarching parameter values, the remote device 110 generates a first set of parameter values 114, and a second set of parameter values 116.

Following receipt of the first and second sets of parameter values, the edge device 130 segregates the storage of these parameters based on their sensitivity. The processing unit 134 stores the unprotected parameter values 212 in the unprotected memory 142. Similarly, the processing unit 134 sends the protected parameter values 210 across the internal partition to the first processor block to be stored exclusively within the protected memory 138.

During active model execution, the two processing partitions collaboratively compute the neural network's results through a secure hybrid inference protocol. In FIG. 2A, the arrows describe the exchange of randomized output between the protected 132 and unprotected 134 processing blocks. Specifically, the trusted processing unit 136 mathematically masks an intermediate calculation by adding a random vector, and sends this randomized output to the untrusted processing unit 140.

After the unprotected processor block 134 performs heavy computations using the non-sensitive unprotected parameter values 212, it sends a randomized second output back across the partition. The processing unit 136 then receives this randomized second output, derives the true output of the layer by mathematically removing the mask, and ultimately combines the evaluations to generate the final output of the model securely within the edge device 130.

FIG. 2B is a diagram illustrating the edge device 130 with protected and unprotected processor blocks 132 and 134, respectively. FIG. 2B details the internal hardware architecture of the edge device 130 configured for the secure execution of a machine learning model. This architecture addresses the technical challenge of securely performing neural network inference locally without exposing the proprietary model data to theft or malicious modification.

Unlike conventional solutions that divide computations between a remote data center and a local device, the system 200 physically co-locates both the trusted and untrusted computational parties within the same edge device 130. These two distinct processing partitions can physically reside on the same motherboard, in the same package, or even within the exact same chip, allowing the device to perform complete inferences locally to satisfy real-time operational requirements or mitigate a lack of network connectivity.

The process begins when the remote device 110 generates a plurality of parameter values. These parameter values represent a fully trained neural network model.

As shown in FIG. 2B, the first highly secure partition within the edge device 130 is designated as the protected processor block 132. Functioning as the trusted party, the protected processor block 132 comprises a dedicated processing unit 136 which is securely coupled to a protected memory 138. Conversely, the second partition is designated as the unprotected processor block 134. Functioning as the untrusted party, the unprotected processor block 134 comprises its own independent processing unit 140 coupled to an unprotected memory 142.

Upon generating model parameter values, the remote device 110 is configured to perform a mathematical decomposition. From these overarching parameter values, the remote device 110 generates a first set of parameter values, represented in FIG. 2B as the protected parameter values 210, and a second set of parameter values, represented as the unprotected parameter values 212.

Following receiving the two parameter sets, the edge device 130 segregates the storage of these parameters based on their sensitivity. The processing unit 134 stores the parameter values 116 in the unprotected memory 142 as unprotected parameter values 212. Simultaneously, the processing unit 134 sends the protected parameter values 114 across the internal partition to the first processor block to be stored exclusively within the protected memory 138 as protected parameter values 210.

This separation is mathematically rooted in a technique such as Singular Value Decomposition (SVD), wherein the protected parameter values 210 consist of the top singular components or a first set of weights. The unprotected parameter values 212 consist of the remaining weights, which constitute the vast majority of the model's size but bear zero information regarding the full functional model if intercepted by an attacker in isolation.

To access these highly sensitive components during active inference without exposing them to vulnerabilities, the processing unit 136 utilizes on-the-fly decryption and authentication 220. Only the small fraction of parameters managed by the trusted party are stored in this encrypted format and decrypted exactly when they are used. This targeted approach makes securing the model much more computationally affordable than attempting the on-the-fly decryption of all model parameters, which would severely bottleneck the system.

Furthermore, the on-the-fly decryption and authentication 220 process guarantees the integrity of the trusted party's data through cryptographic mechanisms like AES GCM. Because the edge device is physically accessible, this processing utilizes efficient encryption algorithms and implementations (such as Ascon, PRESENT, RAMBAM, or STORM) that are rigorously protected against physical exploits, including side-channel and fault injection attacks.

During active model execution, the two processing partitions collaboratively compute the neural network's results through a secure hybrid inference protocol. As depicted in the diagram, the arrows describe the exchange of randomized output between the protected 132 and unprotected 134 processing blocks. Specifically, the trusted processing unit 136 mathematically masks an intermediate calculation by adding a random vector and sends this randomized output across the partition to the untrusted processing unit 140.

After the unprotected processor block 134 performs heavy computations using the non-sensitive unprotected parameter values 212, it sends a randomized second output back across the partition. The processing unit 136 then receives this randomized second output, verifies the calculation's integrity, derives the true output of the layer by mathematically removing the mask, and ultimately combines the evaluations to generate the final output of the model securely within the edge device 130.

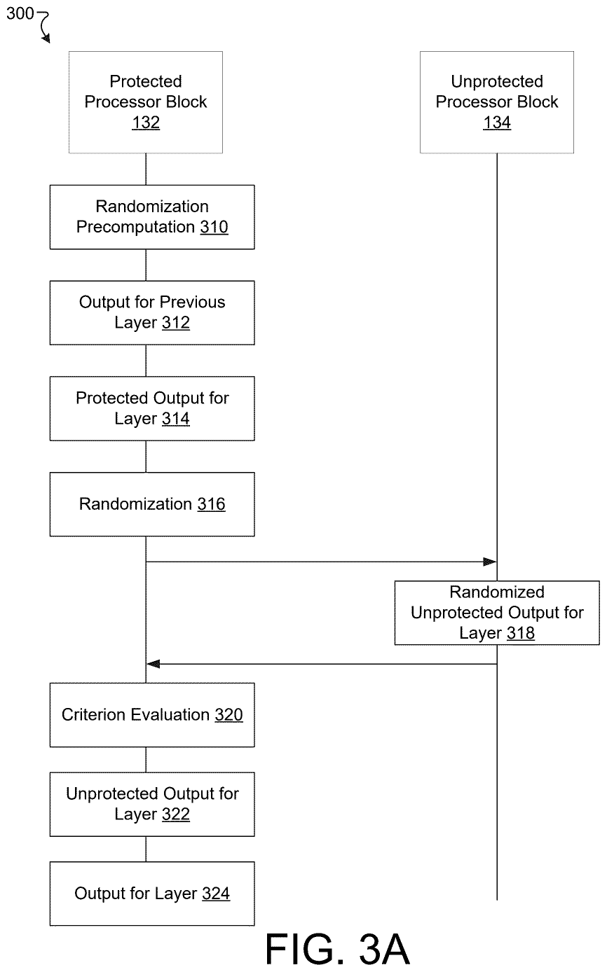

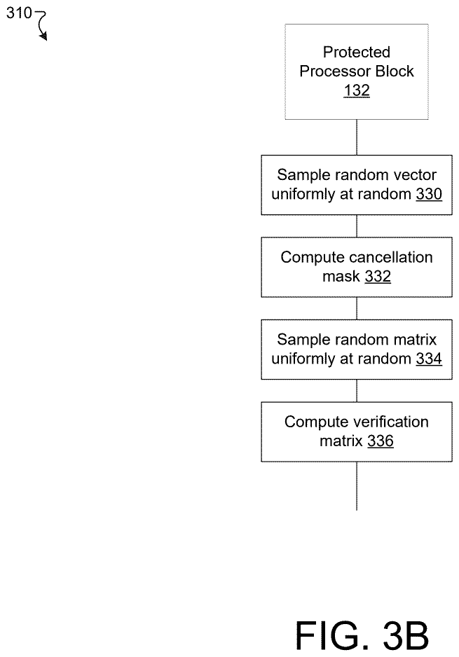

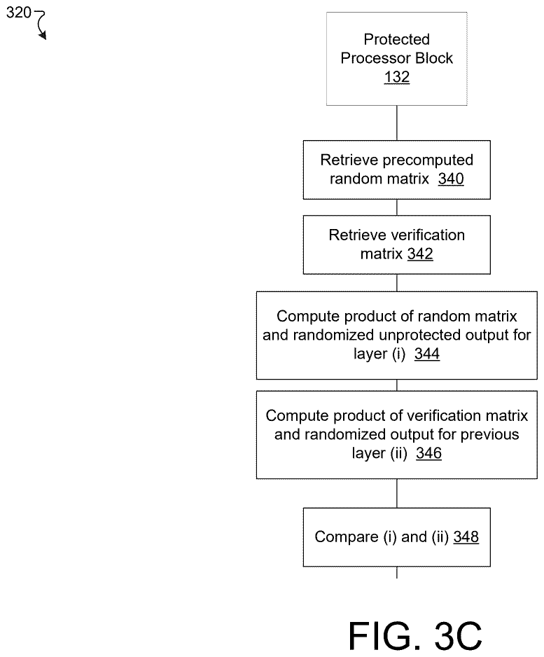

FIG. 3A illustrates a sequence diagram 300 of a secure hybrid inference protocol executing between a trusted Protected Processor Block 132 and an untrusted Unprotected Processor Block 134.

Prior to the online inference for a specific layer i, the Protected Processor Block 132 performs a Randomization Precomputation 310. During this off-line phase, the trusted block samples a random mask rᵢ₋₁ uniformly at random and computes a cancellation mask defined as

$${c}_{i} = {W}_{i}^{𝒟} \cdot {r}_{i - 1} ,$$

where

$${W}_{i}^{𝒟}$$

represents the unprotected portion of the weight matrix. For integrity checking, it also samples a random matrix Zᵢ₋₁ uniformly at random and computes a verification matrix

$${V}_{i - 1} = {Z}_{i - 1} \cdot {W}_{i}^{𝒟} .$$

During the active, on-line inference instance, the Protected Processor Block 132 receives the Output for Previous Layer 312, denoted mathematically as aᵢ₋₁. Using the sensitive portion of the weights retained in the secure enclave

$$( {W}_{i}^{𝒞} ) .$$

the trusted block computes the Protected Output for Layer 314, defined as

$${a}_{i}^{𝒞} = {W}_{i}^{𝒞} \cdot {a}_{i - 1} .$$

At about the same time, to securely offload the bulk computations, the Protected Processor Block 132 performs Randomization 316. It masks the input by adding the pre-computed random vector, generating ãᵢ₋₁=aᵢ₋₁+rᵢ₋₁, and sends this obfuscated data across the partition.

The Unprotected Processor Block 134 receives this masked data and performs its local compute using the non-sensitive, offloaded weights

$$( {W}_{i}^{𝒟} ) .$$

This produces the Randomized Unprotected Output for Layer 318, denoted as

$${\tilde{a}}_{i}^{𝒟} = {W}_{i}^{𝒟} \cdot {\tilde{a}}_{i - 1}$$

which is subsequently returned to the trusted block.

Upon receiving the computation from the untrusted side, the Protected Processor Block 132 performs a Criterion Evaluation 320 to verify the integrity of the data. It executes a linear layer check by retrieving the pre-computed random and verification matrices, evaluating whether

$${Z}_{i - 1} \cdot {\tilde{a}}_{i}^{𝒟} = {V}_{i - 1} \cdot {\tilde{a}}_{i - 1} .$$

If this check fails, the trusted block rejects the computation and aborts by outputting ⊥.

If the criterion is successfully met, the Protected Processor Block 132 unmasks the data to derive the true Unprotected Output for Layer 322, denoted as

$${a}_{i}^{𝒟} .$$

This is achieved by subtracting the pre-computed cancellation mask:

$${a}_{i}^{𝒟} = {\tilde{a}}_{i}^{𝒟} - {c}_{i} = {W}_{i}^{𝒟} ( {\tilde{a}}_{i - 1} - {r}_{i - 1} ) = {W}_{i}^{𝒟} \cdot {a}_{i - 1} .$$

The Protected Processor Block 132 combines the secure and unmasked unsecured evaluations to generate the final Output for Layer 324, denoted as aᵢ. This final output is computed by applying an activation function to the summed components, such that

$${a}_{i} = σ ( {a}_{i}^{𝒞} + {a}_{i}^{𝒟} ) = σ ( ( {W}_{i}^{𝒞} + {W}_{i}^{𝒟} ) \cdot {a}_{i - 1} ) = σ ( {W}_{i} \cdot {a}_{i - 1} ) ,$$

where σ is an activation function.

FIG. 3B illustrates a sequence diagram detailing the Randomization Precomputation 310 phase, which is executed off-line by the trusted Protected Processor Block 132 prior to an active, on-line inference instance for a specific neural network layer.

During this pre-computation phase, the Protected Processor Block 132 first executes a step to sample random vector uniformly at random 330. Mathematically, this corresponds to sampling a random mask rᵢ₋₁. Next, the trusted block uses this random vector to compute cancellation mask 332. This cancellation mask cᵢ is calculated as the product of the non-sensitive portion of the weight matrix

$${W}_{i}^{𝒟}$$

and the random mask, defined as

$${c}_{i} = {W}_{i}^{𝒟} \cdot {r}_{i - 1} .$$

To prepare for a secure integrity check of the untrusted hardware's future calculations, the Protected Processor Block 132 also performs a step to sample random matrix uniformly at random 334, generating a random matrix Zᵢ₋₁. Finally, the trusted block uses this random matrix to compute verification matrix 336. This verification matrix Vᵢ₋₁ may be derived by multiplying the random matrix by the unprotected weight matrix, such that

$${V}_{i - 1} = {Z}_{i - 1} \cdot {W}_{i}^{𝒟} .$$

These pre-computed values are then stored securely by the trusted block to be used later during the on-line unmasking and verification steps of the secure hybrid inference protocol.

FIG. 3C illustrates a sequence diagram detailing the Criterion Evaluation 320 phase of the secure hybrid inference protocol. This critical integrity-checking phase is executed on-line by the highly secure Protected Processor Block 132 (acting as the trusted party) immediately after it receives the outsourced computational results from the untrusted device partition. The primary purpose of this sequence is to verify that the untrusted partition performed the correct linear algebra operations and did not maliciously modify the data during its local computation.

The sequence begins with the Protected Processor Block 132 executing a step to retrieve precomputed random matrix 340. Mathematically, this corresponds to retrieving the random matrix Zᵢ₋₁, which was generated uniformly at random during an off-line pre-computation phase prior to the active inference. Next, the trusted block executes a step to retrieve verification matrix 342. This pulls the pre-computed verification matrix Vᵢ₋₁.

With these pre-computed components in hand, the trusted block performs two distinct mathematical evaluations to test the untrusted party's work. First, it executes a step to compute product of random matrix and randomized unprotected output for layer (i) 344. In this step, the trusted block multiplies the retrieved random matrix Zᵢ₋₁ by the randomized output just returned from the untrusted party

$${\tilde{a}}_{i}^{𝒟} .$$

This calculates the first half of the linear layer check:

$${Z}_{i - 1} \cdot {\tilde{a}}_{i}^{𝒟} .$$

Second, the trusted block executes a step to compute product of verification matrix and randomized output for previous layer (ii) 346. Here, the trusted block multiplies the retrieved verification matrix Vᵢ₋₁ by the obfuscated input ãᵢ₋₁ that it had originally sent across the partition to the untrusted device

Finally, the Protected Processor Block 132 executes a step to compare (i) and (ii) 348. This comparison evaluates whether the two computed products are mathematically equal, checking if

$${Z}_{i - 1} \cdot {\tilde{a}}_{i}^{𝒟} = {V}_{i - 1} \cdot {\tilde{a}}_{i - 1} .$$

If this criterion is satisfied, the trusted block accepts the calculation as valid, proving that the untrusted hardware performed the exact matrix multiplications requested. The protocol can then proceed to safely unmask the data and derive the true final output. If the comparison fails, it indicates an error or a malicious alteration by the untrusted hardware, prompting the trusted block to reject the computation entirely and safely abort the inference process by outputting ⊥.

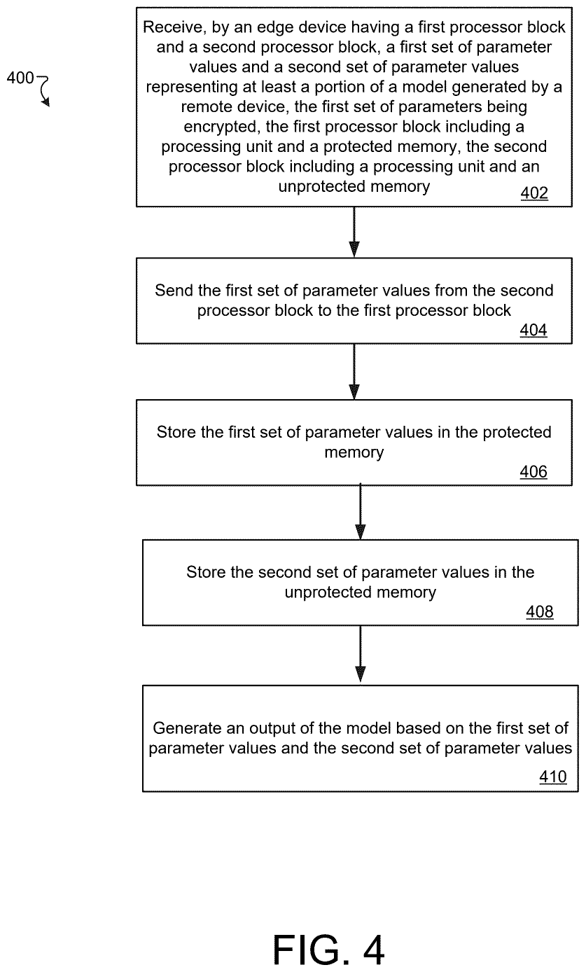

FIG. 4 is a flow chart illustrating an example method 400 of storing a model and performing inference. The method 400 may be performed in processing circuitry, e.g., processing unit 136 (FIG. 2A).

At 402, a processing unit of an edge device (e.g., edge device 130) having a first processor block (e.g., first processor block 132) and a second processor block (e.g., second processor block 134) receives a first set of parameter values (e.g., parameter values 114) representing at least a portion of a model (e.g., model 112), the first set of parameter values being encrypted, and a second set of parameter values (e.g., parameter values 116), the first processor block including a processing unit (e.g., processing unit 136) and a protected memory (e.g., protected memory 138), the second processor block including a processing unit (e.g., processing unit 140) and an unprotected memory (e.g., unprotected memory 142).

At 404, the processing unit sends the first set of parameter values from the second processor block to the first processor block.

At 406, the processing unit stores the first set of parameter values in the protected memory.

At 408, the processing unit stores the second set of parameter values in the unprotected memory.

At 410, the processing unit generates an output (e.g., output 322) of the model based on the first set of parameter values and the second set of parameter values.

Example 1. A method, comprising: receiving, by an edge device having a first processor block and a second processor block, a first set of parameter values and a second set of parameter values representing at least a portion of a model generated by a remote device, the first set of parameter values being encrypted, the first processor block including a processing unit and a protected memory, the second processor block including a processing unit and an unprotected memory; sending the first set of parameter values from the second processor block to the first processor block; storing the first set of parameter values in the protected memory; storing the second set of parameter values in the unprotected memory; and generating an output of the model based on the first set of parameter values and the second set of parameter values.

Example 2. The method as in example 1, wherein the model includes a layer, the first set of parameter values is a first matrix and the second set of parameter values is a second matrix; and wherein generating the output of the model includes: receiving an output of a previous layer of the model; multiplying the output of the previous layer by the first matrix to produce a first output of the layer; sending a randomized output based on the output of the previous layer to the processing unit of the second processor block; after sending the randomized output, receiving a randomized second output of the layer; and deriving a second output of the layer based on the randomized second output of the layer, the output of the model being based on the first output of the model and the second output of the model.

Example 3. The method as in example 2, further comprising: generating a random vector based on a probability distribution function; and producing the randomized output by combining the random vector to the output of the previous layer.

Example 4. The method as in example 2, wherein the randomized second output of the layer is based on a product of the second matrix and the randomized output of the previous layer.

Example 5. The method as in example 2, wherein deriving the second output of the layer includes: generating a random vector based on a probability distribution function; generating a mask by multiplying the random vector by the second matrix; and combining the mask and the randomized second output of the layer.

Example 6. The method as in example 2, wherein the second output of the layer is derived in response to a criterion being satisfied, the criterion being based on the randomized second output of the layer and the randomized output of the previous layer.

Example 7. The method as in example 6, further comprising: generating a random matrix based on a probability distribution function; and generating a verification matrix by multiplying the second matrix by the random matrix, wherein the criterion is satisfied in response to a product of the verification matrix and the randomized output of the previous layer being equal to a product of the random matrix and the randomized second output of the layer.

Example 8. The method as in example 1, wherein generating the output of the model includes: performing an on-the-fly decryption of the first set of parameter values.

Example 9. The method as in example 1, wherein a decryption of the first set of parameter values is configured to protect the first set of parameter values against side-channel attacks.

Example 10. The method as in example 1, wherein storing the first set of parameter values in the protected memory includes: performing an authentication of the first set of parameter values.

Example 11. The method as in example 1, wherein storing the second set of parameter values in the unprotected memory includes: performing an authentication of the second set of parameter values

Example 12. A computer program product comprising a nontransitory storage medium, the computer program product including code that, when executed by processing circuitry, causes the processing circuitry to perform a method, the method comprising: receiving, by an edge device having a first processor block and a second processor block, a first set of parameter values and a second set of parameter values representing at least a portion of a model generated by a remote device, the first set of parameter values being encrypted, the first processor block including a processing unit and a protected memory, the second processor block including a processing unit and an unprotected memory; sending the first set of parameter values from the second processor block to the first processor block; storing the first set of parameter values in the protected memory; storing the second set of parameter values in the unprotected memory; and generating an output of the model based on the first set of parameter values and the second set of parameter values.

Example 13. The computer program product as in example 12, wherein the model includes a layer, the first set of parameter values is a first matrix and the second set of parameter values is a second matrix; and wherein generating the output of the model includes: receiving an output of a previous layer of the model; multiplying the output of the previous layer by the first matrix to produce a first output of the layer; sending a randomized output based on the output of the previous layer to the processing unit of the second processor block; after sending the randomized output, receiving a randomized second output of the layer; and deriving a second output of the layer based on the randomized second output of the layer, the output of the model being based on the first output of the model and the second output of the model.

Example 14. The computer program product as in example 13, further comprising: generating a random vector based on a probability distribution function; and producing the randomized output by adding the random vector to the output of the previous layer.

Example 15. Processing circuitry configured to perform a method, the method comprising: receiving, by an edge device having a first processor block and a second processor block, a first set of parameter values and a second set of parameter values representing at least a portion of a model generated by a remote device, the first set of parameter values being encrypted, the first processor block including a processing unit and a protected memory, the second processor block including a processing unit and an unprotected memory; sending the first set of parameter values from the second processor block to the first processor block; storing the first set of parameter values in the protected memory; storing the second set of parameter values in the unprotected memory; and generating an output of the model based on the first set of parameter values and the second set of parameter values.

Example 16. A system, comprising: a remote device, comprising: memory; and processing circuitry coupled to the memory, the processing circuitry being configured to: generate a plurality of parameter values representing a model; generate, from the plurality of parameter values, a first set of parameter values and a second set of parameter values; and encrypt the first set of parameter values; and an edge device having a first processor block and a second processor block, the first processor block comprising: a protected memory; and a processing unit coupled to the protected memory; the second processor block comprising: an unprotected memory; and a processing unit coupled to the unprotected memory; the processing unit of the first processor block being configured to: store the first set of parameter values in the protected memory; store the second set of parameter values in the unprotected memory; and generate an output of the model based on the first set of parameter values and the second set of parameter values.

Example 17. The system as in example 16, wherein the model includes a layer, the layer being represented as a matrix of parameter values of the plurality of parameter values; wherein the processing circuitry of the remote device configured to generate the first set of parameter values and the second set of parameter values is further configured to: derive a plurality of weights and a plurality of submatrices based on the matrix, each of the plurality of submatrices being associated with a respective weight of the plurality of weights; and determine a first set of weights of the plurality of weights and a second set of weights of the plurality of weights, the first set of parameter values being a weighted sum of a first set of submatrices of the plurality of submatrices associated with the first set of weights, the second set of parameter values being the weighted sum of a second set of submatrices of the plurality of submatrices associated with the second set of weights.

Example 18. The system as in example 16, wherein the model includes a layer, the first set of parameter values is a first matrix and the second set of parameter values is a second matrix; and wherein the processing unit configured to generate the output of the model is further configured to: receive an output of a previous layer of the model; multiply the output of the previous layer by the first matrix to produce a first output of the layer; send a randomized output based on the output of the previous layer to the processing unit of the second processor block; after sending the randomized output, receive a randomized second output of the layer; and derive a second output of the layer based on the randomized second output of the layer, the output of the model being based on the first output of the model and the second output of the model.

Example 19. The system as in example 18, wherein the processing unit is further configured to: generate a random vector based on a probability distribution function; and produce the randomized output by adding the random vector to the output of the previous layer.

Example 20. The system as in example 18, wherein the randomized second output of the layer is based on a product of the second matrix and the randomized output of the previous layer.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining or displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method, comprising:
receiving, by an edge device having a first processor block and a second processor block, a first set of parameter values and a second set of parameter values representing at least a portion of a model generated by a remote device, the first set of parameter values being encrypted, the first processor block including a processing unit and a protected memory, the second processor block including a processing unit and an unprotected memory;
sending the first set of parameter values from the second processor block to the first processor block;
storing the first set of parameter values in the protected memory;
storing the second set of parameter values in the unprotected memory; and
generating an output of the model based on the first set of parameter values and the second set of parameter values.

2. The method as in claim 1, wherein the model includes a layer, the first set of parameter values is a first matrix and the second set of parameter values is a second matrix; and
wherein generating the output of the model includes:
receiving an output of a previous layer of the model;
multiplying the output of the previous layer by the first matrix to produce a first output of the layer;
sending a randomized output based on the output of the previous layer to the processing unit of the second processor block;
after sending the randomized output, receiving a randomized second output of the layer; and
deriving a second output of the layer based on the randomized second output of the layer, the output of the model being based on the first output of the model and the second output of the model.

3. The method as in claim 2, further comprising:
generating a random vector based on a probability distribution function; and
producing the randomized output by combining the random vector to the output of the previous layer.

4. The method as in claim 2, wherein the randomized second output of the layer is based on a product of the second matrix and the randomized output of the previous layer.

5. The method as in claim 2, wherein deriving the second output of the layer includes:
generating a random vector based on a probability distribution function;
generating a mask by multiplying the random vector by the second matrix; and
combining the mask and the randomized second output of the layer.

6. The method as in claim 2, wherein the second output of the layer is derived in response to a criterion being satisfied, the criterion being based on the randomized second output of the layer and the randomized output of the previous layer.

7. The method as in claim 6, further comprising:
generating a random matrix based on a probability distribution function; and
generating a verification matrix by multiplying the second matrix by the random matrix, wherein the criterion is satisfied in response to a product of the verification matrix and the randomized output of the previous layer being equal to a product of the random matrix and the randomized second output of the layer.

8. The method as in claim 1, wherein generating the output of the model includes:
performing an on-the-fly decryption of the first set of parameter values.

9. The method as in claim 1, wherein a decryption of the first set of parameter values is configured to protect the first set of parameter values against side-channel attacks.

10. The method as in claim 1, wherein storing the first set of parameter values in the protected memory includes:
performing an authentication of the first set of parameter values.

11. The method as in claim 1, wherein storing the second set of parameter values in the unprotected memory includes:
performing an authentication of the second set of parameter values.

12. A computer program product comprising a nontransitory storage medium, the computer program product including code that, when executed by processing circuitry, causes the processing circuitry to perform a method, the method comprising:
receiving, by an edge device having a first processor block and a second processor block, a first set of parameter values and a second set of parameter values representing at least a portion of a model generated by a remote device, the first set of parameter values being encrypted, the first processor block including a processing unit and a protected memory, the second processor block including a processing unit and an unprotected memory;
sending the first set of parameter values from the second processor block to the first processor block;
storing the first set of parameter values in the protected memory;
storing the second set of parameter values in the unprotected memory; and
generating an output of the model based on the first set of parameter values and the second set of parameter values.

13. The computer program product as in claim 12, wherein the model includes a layer, the first set of parameter values is a first matrix and the second set of parameter values is a second matrix; and
wherein generating the output of the model includes:
receiving an output of a previous layer of the model;
multiplying the output of the previous layer by the first matrix to produce a first output of the layer;
sending a randomized output based on the output of the previous layer to the processing unit of the second processor block;
after sending the randomized output, receiving a randomized second output of the layer; and
deriving a second output of the layer based on the randomized second output of the layer, the output of the model being based on the first output of the model and the second output of the model.

14. The computer program product as in claim 13, further comprising:
generating a random vector based on a probability distribution function; and
producing the randomized output by adding the random vector to the output of the previous layer.

15. Processing circuitry configured to perform a method, the method comprising:
receiving, by an edge device having a first processor block and a second processor block, a first set of parameter values and a second set of parameter values representing at least a portion of a model generated by a remote device, the first set of parameter values being encrypted, the first processor block including a processing unit and a protected memory, the second processor block including a processing unit and an unprotected memory;
sending the first set of parameter values from the second processor block to the first processor block;
storing the first set of parameter values in the protected memory;
storing the second set of parameter values in the unprotected memory; and
generating an output of the model based on the first set of parameter values and the second set of parameter values.

16. A system, comprising:
a remote device, comprising:
memory; and
processing circuitry coupled to the memory, the processing circuitry being configured to:
generate a plurality of parameter values representing a model;
generate, from the plurality of parameter values, a first set of parameter values and a second set of parameter values; and
encrypt the first set of parameter values; and
an edge device having a first processor block and a second processor block, the first processor block comprising:
a protected memory; and
a processing unit coupled to the protected memory;
the second processor block comprising:
an unprotected memory; and
a processing unit coupled to the unprotected memory;
the processing unit of the first processor block being configured to:
store the first set of parameter values in the protected memory;
store the second set of parameter values in the unprotected memory; and
generate an output of the model based on the first set of parameter values and the second set of parameter values.

17. The system as in claim 16, wherein the model includes a layer, the layer being represented as a matrix of parameter values of the plurality of parameter values;
wherein the processing circuitry of the remote device configured to generate the first set of parameter values and the second set of parameter values is further configured to:
derive a plurality of weights and a plurality of submatrices based on the matrix, each of the plurality of submatrices being associated with a respective weight of the plurality of weights; and
determine a first set of weights of the plurality of weights and a second set of weights of the plurality of weights, the first set of parameter values being a weighted sum of a first set of submatrices of the plurality of submatrices associated with the first set of weights, the second set of parameter values being the weighted sum of a second set of submatrices of the plurality of submatrices associated with the second set of weights.

18. The system as in claim 16, wherein the model includes a layer, the first set of parameter values is a first matrix and the second set of parameter values is a second matrix; and
wherein the processing unit configured to generate the output of the model is further configured to:
receive an output of a previous layer of the model;
multiply the output of the previous layer by the first matrix to produce a first output of the layer;
send a randomized output based on the output of the previous layer to the processing unit of the second processor block;
after sending the randomized output, receive a randomized second output of the layer; and
derive a second output of the layer based on the randomized second output of the layer, the output of the model being based on the first output of the model and the second output of the model.

19. The system as in claim 18, wherein the processing unit is further configured to:
generate a random vector based on a probability distribution function; and
produce the randomized output by adding the random vector to the output of the previous layer.

20. The system as in claim 18, wherein the randomized second output of the layer is based on a product of the second matrix and the randomized output of the previous layer.
